(19) United States
(12) Patent Application Publication
(10) Pub. No.: US 2004/0202516 A1
(43) Pub. Date: Oct. 14, 2004

(54) Attitude independent portable press for hand held tool and method

(76) Inventor: Jerry L. Lanser, Longmont, CO (US)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(21) Appl. No.: 10/410,906

(22) Filed: Apr. 11, 2003

(51) Int. Cl. B23B 35/00

(52) U.S. Cl. 408/1 R

(57) ABSTRACT

A portable press and method are disclosed for use primarily with hand held power tools, and especially electric or pneumatic drill motors having a pistol-type hand grip. The press includes a mounting assembly and an operational guide assembly, the mounting assembly having a tool support bracket, a clamping support ring, and a resilient support. The operational guide assembly includes a support arm bracket having the tool support bracket connected therewith and a support arm extending therefrom at an angle normal to the mounting assembly, a pair of interface guides, and an interface tensioning mechanism. An interface, a sufficient length of durable webbing or strap for example, is engagable around a workpiece and the guides, and is operably associable with the tensioning mechanism. The location of the guides at the support arm bracket is selected to locate the tool support bracket therebetween.

### FIELD OF THE INVENTION

This invention relates to portable hand tool operation, and, more particularly, relates to portable presses for hand held drill motors or the like.

### BACKGROUND OF THE INVENTION

Hand held power tools are widely utilized in the field for various construction, repair and maintenance operations. The portability of such tools have made them an efficient and effective choice for site-based operations. Such tools, however, are inherently unstable, imprecise and difficult to employ for some operations.

For example, hand held drill motors having pistol-type hand grips are difficult to use on slick or uneven surfaces, having a tendency to “walk” from the desired drilling location upon initial motor start-up. Moreover, such drill motors tend toward binding of the bit in the workpiece, especially at difficult or awkward attack angles. Finally, at some drilling site locations, maintenance of sufficient working force (pressure applied at the drill bit to the workpiece) is difficult.

In an effort to address these shortcomings, a number of apparatus have heretofore been suggested and/or utilized for stabilizing the tool and/or aiding in application of drilling pressure at the bit (see, for example, U.S. Pat. Nos. 641,922, 2,947,205, 3,834,828, 3,957,387, 3,248,973, 2,827,807, 2,695,525, 2,667,092, 5,890,851, 4,168,926 and 1,184,829). Such heretofore known apparatus have, however, met with limited acceptance, due at least in part to lack of sufficient work site adaptability (for example, the ability to operate independent of attitude of tool operation), operational stability and ease of use, and/or ability to operate without undue occurrence of workpiece binding. Further improvement could thus yet be utilized.

### SUMMARY OF THE INVENTION

This invention provides a portable press for stabilizing and applying continuing pressure during operation of a portable hand tool such as a drill motor and related method. The press is attitude independent, is simple and stable to operate, and is configured to help limit occurrences of binding of the hand tool at the work piece during use.

The portable press includes a mounting assembly connected with an operational guide assembly, the mounting assembly including spaced forward and rearward hand tool supports. The operational guide assembly has a support arm bracket with first and second spaced guides connected therewith. The guides are positioned with at least one of the hand tool supports (preferably the rearward support) of the mounting assembly therebetween. A tensioning mechanism is mounted at the support arm bracket for tensioning a workpiece engageble interface maintainable around the guides.

The press is hand held and particularly well adapted for use with a hand held drill motor of the variety having a pistol-type grip extending from main body and having a drill chuck at an opposite end thereof. The forward support of the mounting assembly is preferably a support collar configured to receive the drill chuck of the drill motor therethrough, while the rearward support is preferably a bracket including a rear wall attached to the support arm bracket. The rearward support bracket includes a resilient member and is configured to receive the grip of the drill motor. The support collar and rearward support bracket are cooperatively associated for adjustment to accept and release the drill motor and apply sufficient force to grip the drill motor therebetween.

The support arm bracket includes a support arm that extends therefrom at an angle normal to the mounting assembly. The tensioning mechanism is preferably a ratchet assembly mounted at the support arm bracket and including a ratchet handle operative in association with the support arm by a user of the tool. The interface is preferably a strap tensioned by the ratchet assembly.

The method of this invention provides for stable application of substantially constant drill bit pressure to a workpiece by a hand held power drill motor independent of attitude of operation of the drill motor. The drill motor is held at forward and rearward locations fixed relative to one another during drill motor operation. An interface is engaged around the workpiece and with the drill motor at opposite sides of at least one of the locations. The interface is tensioned during operation of the drill motor to draw the drill motor and the workpiece toward one another. The drill bit in the drill motor is thus drawn into contact with the workpiece in a relatively constant directional orientation relative to the workpiece due to work force application substantially equally from opposite sides of the drill motor and drill motor stabilization at both the front and rear of the drill motor.

It is therefore an object of this invention to provide an improved portable press for stabilizing and applying continuing pressure during operation of a portable hand tool and method.

It is another object of this invention to provide a press for use with a portable hand tool that is attitude independent, is simple and stable to operate, and is configured to help limit occurrences of binding of the hand tool at the work piece.

It is still another object of this invention to provide a press for use with a portable hand tool and method wherein a drill bit in a drill motor is drawn into contact with a workpiece in a relatively constant directional orientation relative to the workpiece due to work force application substantially equally from opposite sides of the drill motor and drill motor stabilization at both the front and rear of the drill motor.

It is yet another object of this invention to provide an attitude independent portable press for use with a hand held tool, the press including a mounting assembly including spaced forward and rearward hand tool supports, an operational guide assembly connected with the mounting assembly and including a support arm bracket, first and second spaced guides connected with the support arm bracket and positioned thereat with at least one of the hand tool supports of the mounting assembly therebetween, and a tensioning mechanism mounted at the support arm bracket, and a workpiece engageble interface maintainable around the guides and operationally associable with the tensioning mechanism.

It is still another object of this invention to provide a hand held drill press for use with a hand held drill motor with a pistol-type grip extending from a main body having a drill chuck at an opposite end thereof, the press including a support arm bracket having a support arm extending therefrom, a support collar configured to receive the drill chuck of the drill motor therethrough, a rear support bracket including a rear wall attached to the support arm bracket and having a resilient member configured to receive the grip of the grill motor thereat, the rear support bracket and the support collar including means for cooperative association, first and second spaced guides connected with the support arm bracket and positioned thereat at opposite sides of the rear wall of the rear support bracket, a ratchet assembly mounted at the support arm bracket, and a workpiece engaging strap maintainable around the guides and operationally associable with the ratchet assembly.

It is yet another object of this invention to provide a method for stable application of substantially constant drill bit pressure to a workpiece by a hand held power drill motor independent of attitude of operation of the drill motor, the method including the steps of holding the drill motor at forward and rearward locations fixed relative to one another during drill motor operation, engaging an interface around the workpiece, engaging the interface with the drill motor at opposite sides of at least one of the locations, and tensioning the interface during operation of the drill motor to draw the drill motor and the workpiece toward one another.

With these and other objects in view, which will become apparent to one skilled in the art as the description proceeds, this invention resides in the novel construction, combination, and arrangement of parts and method substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of the portable press of this invention in use with a portable hand held power tool (a drill motor);

FIG. 2 is a perspective view of the press of FIG. 1;

FIG. 3 is an exploded view of the portable press of FIG. 1; and

FIG. 4 is a bottom plan view of the press of FIG. 1 with ghosted sections.

### DESCRIPTION OF THE INVENTION

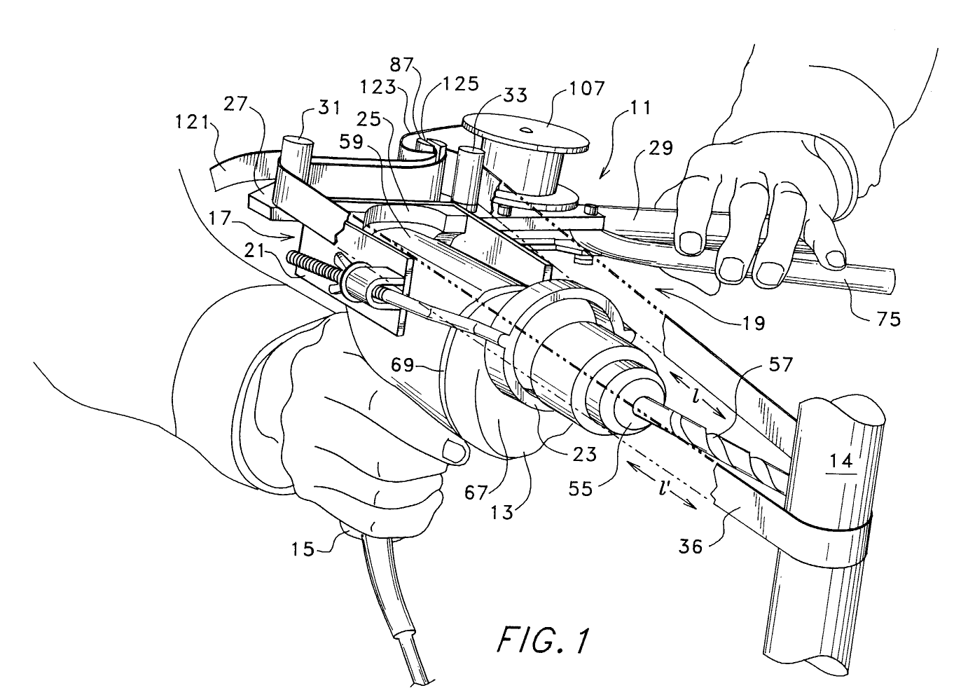

FIG. 1 illustrates portable hand held press 11 in use with a power tool 13, a hand held drill motor, boring a hole in a workpiece (pipe 14). Press 11 is designed for use primarily with hand held power tools, and especially electric or pneumatic drill motors having a pistol-type hand grip 15 including an on/off switch (or trigger, not shown), though the press of this invention could be adapted for use with other types of power hand tools.

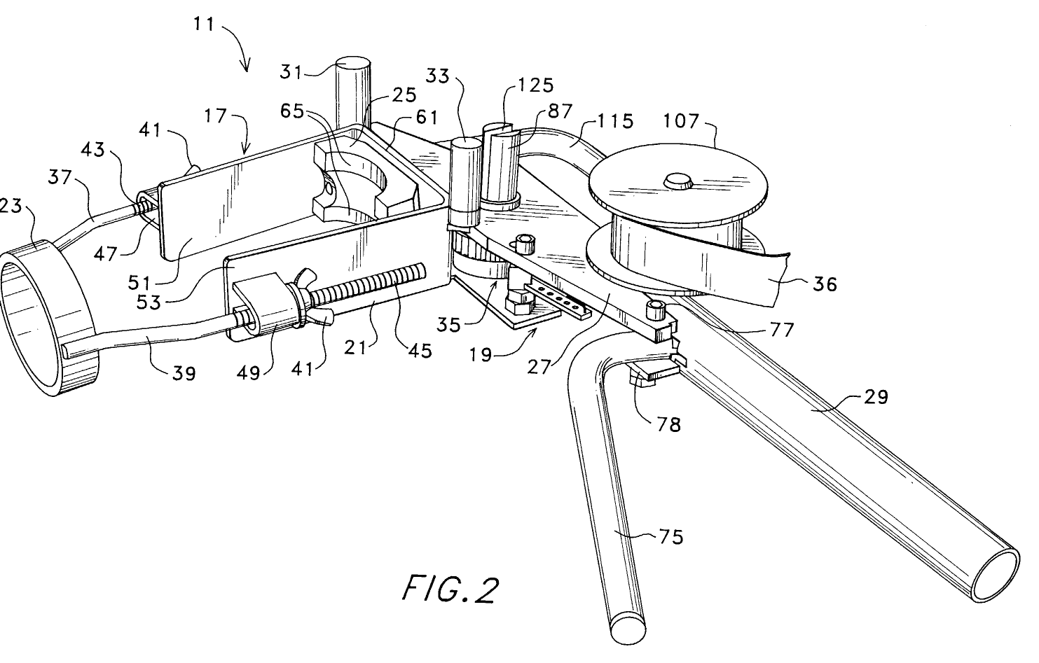

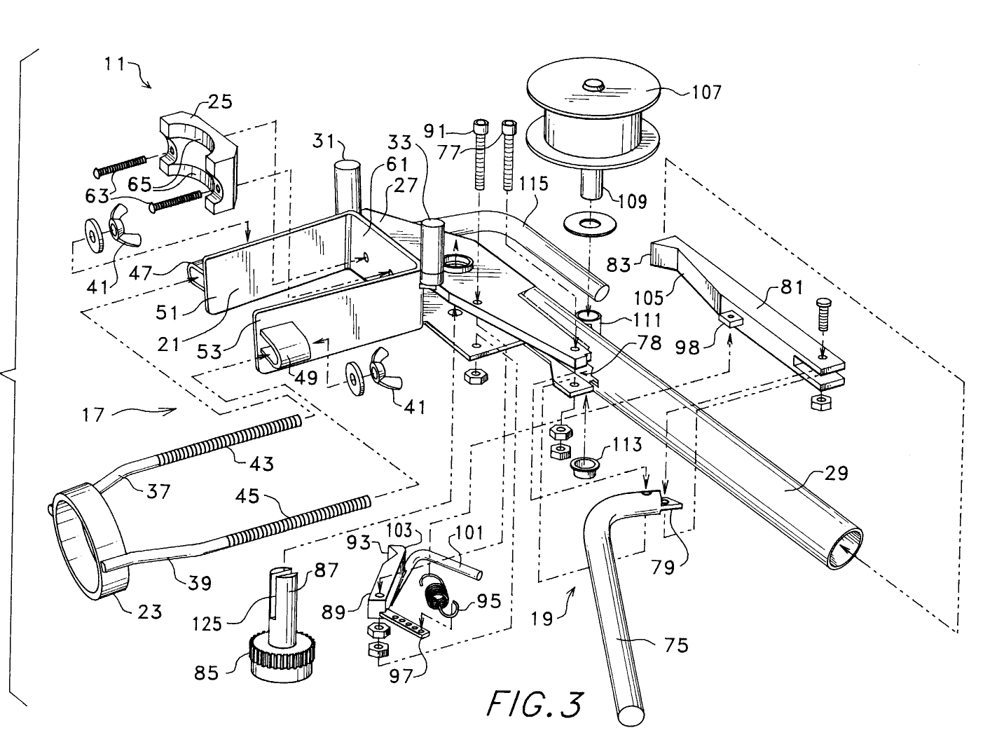

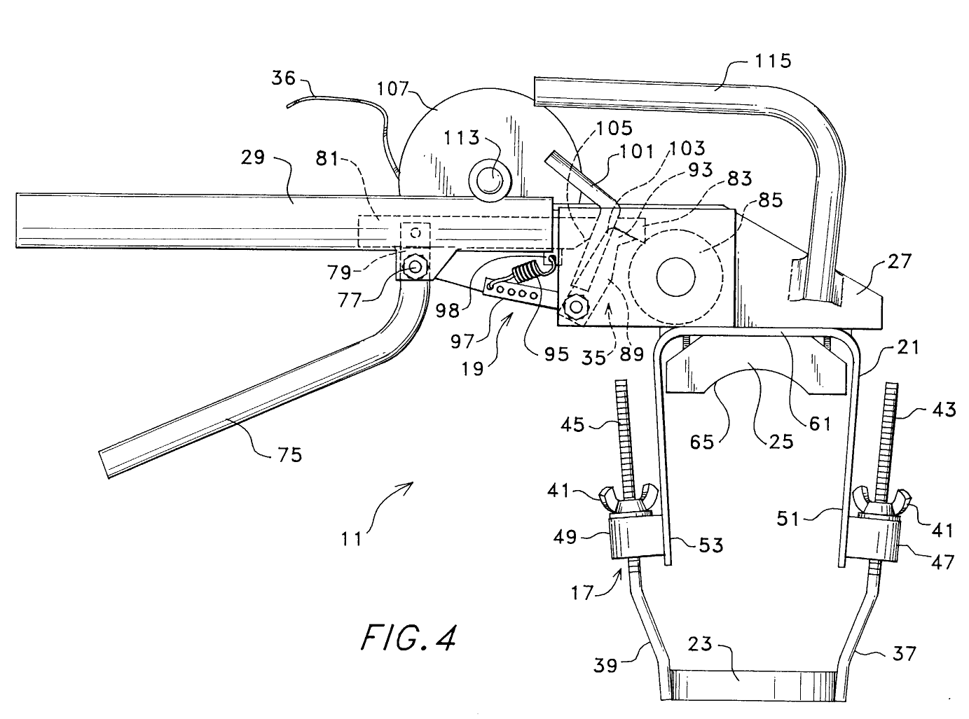

As shown in FIGS. 1 through 4, press 11 includes mounting assembly 17 and operational guide assembly 19. Mounting assembly 17 includes tool (in this case adapted for a power drill as described above) support bracket 21, clamping support ring 23 and resilient support 25. Operational guide assembly 19 includes support arm bracket 27 having drill support bracket 21 connected therewith and having support arm 29 extending therefrom at an angle normal to mounting assembly 17, interface guides 31 and 33, and interface tensioning mechanism 35. Interface 36, a sufficient length of durable webbing or strap for example, is engaged at workpiece 14 and guides 31 and 33 and is operably associable with tensioning mechanism 35 as discussed hereinafter. Interface 36, when a strap is used as shown herein, is preferably of nylon or other tear resistant and durable material.

Drill clamping support ring 23 is held spaced from drill support bracket 21 on threaded frame rods 37 and 39 welded to ring 23 thus providing drill motor holding locations that are fixed relative to one another during drill motor operation. Ring 23 is moved away from drill support bracket 21 by loosening nuts 41 (knurled nuts, wing nuts or the like) allowing threaded shaft portions 43 and 45 of frame rods 37 and 39, respectively, to be moved away from bracket 21 through retaining ears 47 and 49, respectively, at converging limbs 51 and 53, respectively, of drill support bracket 21.

As shown in FIG. 1, drill chuck 55 (releasably receiving drill 57) of drill motor 13 is releasably insertable through clamping ring 23, and heel 59 at hand grip 15 of drill motor 13 is maneuvered into position at resilient support 25 (preferably made of a relatively hard, but yieldable rubber or the like secured to bracket rear wall 61 of drill support bracket 21, for example by screws 63 or the like), with heel 59 resting in conforming surface 65 thereof. As nuts 41 are tightened against ears 47 and 49, drill motor 13 is clamped between clamping support ring 23 (abutting front surface 67 of drill motor housing 69) and rear wall 61 of drill support bracket 21, heel 59 of drill motor 13 being pressed into resilient support 25, thus gripping drill motor 13 at support 25 thereby holding the drill motor in both forward and rearward support locations.

Tensioning mechanism 35 as shown herein is a ratchet assembly. While ratchet assembly 35 is shown, any other means for tensioning the strap known in the art may be utilized. Ratchet assembly 35 may be any common ratchet type assembly adaptable to the use indicated. As shown herein, the assembly includes ratchet handle 75 pivotable toward support arm 29 about pivot pin 77 held at mount 78 formed at support arm bracket/support arm 27/29 joinder (support arm 29 preferably being a made of rigid hollow tubing). Ratchet handle end 79 is pivotably mounted at drive bar 81, pawl 83 at the opposite end of drive bar 81 being engageable in the teeth of ratchet gear 85 rotatably held in journals (not shown) in support arm bracket 27. As may be appreciated, this arrangement allows movement of ratchet gear 85 and thus slotted take-up shaft 87 connected therewith.

Latch 89 is pivotably mounted at pin 91 to support arm bracket 21. Pawl 93 of latch 89 engages teeth of gear 85 limiting gear rotation to a single direction when in the engaging position. Spring 95 is attached between a selected location at latch extension 97 and ear 98 of drive bar 81 to maintain bias of latch 89 toward gear 85 and bias drive bar 81 into engagement with gear 85. Release 101 is attached to latch 89 for movement of latch 89 against its bias. When moved, release 101 brings latch pawl 93 out of engagement with the teeth of gear 85 and cam surface 103 of latch 89 into contact with cam guide surface 105 of drive bar 81 thus disengaging pawl 83 of bar 81 from the teeth of gear 85 and thereby allowing free rotation of gear 85 and shaft 87.

Interface strap storage reel 107 normally holds one end of interface strap 36 and is freely rotatable on its axle 109 through journal mount 111 at support arm 29, maintained thereat by press fit retainer cap 113. Auxiliary manipulation arm 115 is attached to support arm bracket 27 for use as may be deemed necessary by an operator of the tool from time to time.

In use as shown in FIG. 1, after drill motor 13 is mounted in mounting assembly 17, workpiece/drill motor interface strap 36 is wrapped around a workpiece (for example, the pipe 14 shown in FIG. 1) and around the outside of guides 31 and 33. The location of guides 31 and 33 at support arm bracket 27 is selected to locate rear support wall 61 of drill support bracket 21 therebetween so that interface strap 36 is only marginally offset relative to the primary direction of drill motor 13 operation and work force is applied substantially evenly from both sides of the drill motor. Free end 121 and intermediate portion 123 (see FIG. 1) of strap 36 are then positioned in slot 125 of tensioning shaft 87.

The operator holds grip 15 of drill motor 13 with one hand to operate the drill, while holding support arm 29 and ratchet handle 75 of press 11 with the other hand to operate tensioning mechanism 35. When the operator squeezes handle 75 toward arm 29, operation of ratchet assembly 35 and rotation of shaft 87 tensions strap 36 by wrapping strap 36 around shaft 87 decreasing the lengths (1) and (1′) of strap 36 between guides 31 and 33, respectively, and workpiece 14 equally (thereby maintaining substantially constant lateral pressure at each side of drill motor 13 at tensioning continues) and securing strap 36 in slot 125 of shaft 87 when taut.

As ratcheting continues, drill bit 57 in drill motor 24 is drawn into contact with workpiece 14 in a relatively constant directional orientation relative to the workpiece since mounting assembly 17 and operational guide assembly 19 are relatively aligned and operate together to apply work force substantially equally from opposite sides of drill motor 13, and with drill motor 13 stabilized at both the front and rear of the drill motor in mounting assembly 17 (at collar 23 and support 25). The maintenance of such relatively constant directional orientation helps alleviate binding common to such operations.

The operator continues to operate ratchet handle 75 as necessary during drilling to maintain stability and substantially constant pressure between workpiece 14 and drill bit 57 as the bit enters the workpiece. When drilling is complete, the operator depresses latch release 101 at ratchet assembly 35 allowing ratchet gear 85 and thus shaft 87 to rotate in the opposite direction thereby releasing tension on interface 36 allowing it to be removed from around workpiece 14. When not in use, drill motor 13 may be used separately from portable hand held press 11 or stored. Interface strap 36 may be wound for storage at reel 107 when press 11 is not in use.

What is claimed is:

1. An attitude independent portable press for use with a hand held tool, said press comprising:
a mounting assembly including spaced forward and rearward hand tool supports;
an operational guide assembly connected with said mounting assembly and including a support arm bracket, first and second spaced guides connected with said support arm bracket and positioned thereat with at least one of said hand tool supports of said mounting assembly therebetween, and a tensioning mechanism mounted at said support arm bracket; and
a workpiece engageble interface maintainable around said guides and operationally associable with said tensioning mechanism.

2. The portable press of claim 1 wherein said support arm bracket includes a support arm that extends therefrom at an angle normal to said mounting assembly, said tensioning mechanism operable by user holding said support arm with one hand and the hand held tool with another hand.

3. The portable drill press of claim 2 wherein said tensioning mechanism includes a ratchet assembly mounted at said support arm bracket with a ratchet handle operative in association with said support arm by a user of the tool.

4. The portable drill press of claim 1 wherein said forward hand tool support of said mounting assembly includes a support ring adapted to receive a forward portion of the hand held tool therethrough.

5. The portable drill press of claim 4 wherein said rearward hand tool support of said mounting assembly includes a tool support bracket connected with said support arm bracket, said forward hand tool support further including frame rods connected with said support ring each adapted to be adjustably received and securable at said tool support bracket.

6. The portable drill press of claim 1 wherein said mounting assembly includes a resilient support at one of said forward and rearward hand tool supports.

7. A hand held drill press for use with a hand held drill motor with a pistol-type grip extending from a main body having a drill chuck at an opposite end thereof, said press comprising:
a support arm bracket having a support arm extending therefrom;
a support collar configured to receive the drill chuck of the drill motor therethrough;
a rear support bracket including a rear wall attached to said support arm bracket and having a resilient member configured to receive the grip of the grill motor thereat, said rear support bracket and said support collar including means for cooperative association thereof;
first and second spaced guides connected with said support arm bracket and positioned thereat at opposite sides of said rear wall of said rear support bracket;
a ratchet assembly mounted at said support arm bracket; and
a workpiece engaging strap maintainable around said guides and operationally associable with said ratchet assembly.

8. The drill press of claim 7 further comprising a rotatable storage reel holding one end of said strap and freely rotatable at a mount at one of said support arm bracket and said support arm.

9. The drill press of claim 7 wherein said means for cooperative association of said support collar and said rear support bracket are configured for relative position adjustment to accept and release the drill motor and apply sufficient force to grip the drill motor between said support collar and said rear support bracket for use.

10. The drill press of claim 7 wherein said ratchet assembly includes a ratchet handle operative in association with said support arm by a user of the tool to tension said strap.

11. The drill press of claim 10 wherein said ratchet assembly includes a take-up shaft associated with a ratchet gear operable by manipulation of said ratchet handle, said shaft holding said strap at one end of said strap and at an intermediate location along said strap spaced from said one end.

12. The drill press of claim 7 wherein said rear support bracket includes a yieldable member maintained at said rear wall.

13. The drill press of claim 12 wherein said yieldable member has a conforming surface adapted to receive and be caused to grip a rear portion of the pistol-type grip of the drill motor positioned thereat.

14. A method for stable application of substantially constant drill bit pressure to a workpiece by a hand held power drill motor independent of attitude of operation of the drill motor, said method comprising the steps of:
holding the drill motor at forward and rearward locations fixed relative to one another during drill motor operation;
engaging an interface around the workpiece;
engaging said interface with the drill motor at opposite sides of at least one of said locations; and
tensioning said interface during operation of the drill motor to draw the drill motor and the workpiece toward one another with a relatively constant directional orientation.

15. The method of claim 14 further comprising the step of releasing tension on the interface to disengage the workpiece after drilling.

16. The method of claim 14 wherein said forward location is adjacent to the drill bit and said rearward location is adjacent to a hand grip of the drill motor, said at least one of said locations being said rearward location.

17. The method of claim 14 wherein drill motor operation is accomplished with one hand of an operator and tensioning said interface during operation of the drill motor is accomplished with another hand of the operator.

18. The method of claim 14 wherein the step of hold the drill motor at forward and rearward locations includes clamping the drill motor between said forward and rearward locations.

19. The method of claim 18 wherein the step on clamping the drill motor between said forward and rearward locations includes pressing a part of the drill motor into a yieldable support at one of said locations.

20. The method of claim 14 wherein said interface is a strap, said method further comprising the step of reeling said strap from a position adjacent to the held drill motor for deployment and/or storage as required.
